(19) United States
(12) Patent Application Publication
(10) Pub. No.: US 2012/0044212 A1
(43) Pub. Date: Feb. 23, 2012

(54) OPTICAL TOUCH PANEL

(75) Inventor: Toru Mizutani, Osaka (JP)

(73) Assignee: NITTO DENKO CORPORATION, Osaka (JP)

(21) Appl. No.: 13/207,061

(22) Filed: Aug. 10, 2011

(30) Foreign Application Priority Data
Aug. 17, 2010 (JP) 2010-182434

(51) Int. Cl. G06F 3/042

(52) U.S. Cl. 345/175; 178/18.09

(57) ABSTRACT

Light emitting optical waveguide cores are provided in one of opposite side portions located on opposite sides of a detection area, and light receiving optical waveguide cores are provided in the other side portion. Light beams are emitted from distal ends of the light emitting cores disposed along an inner edge of the one side portion, and received on distal ends of the light receiving cores disposed along an inner edge of the other side portion, whereby an optical lattice is defined on the detection area for detection of a touch position. The detection area includes a higher resolution detection portion defined by arranging distal ends of at least some of the light receiving cores at a pitch that is smaller than the pitch of distal ends of the other light receiving cores.

### BACKGROUND OF THE INVENTION

1. Field of the Invention

The present invention relates to an optical touch panel employing optical waveguides.

2. Description of the Related Art

In recent years, optical touch panels of an optical waveguide type, which are easy to maintain in the absence of electrical contacts, have come to be used instead of conventional touch panels of a resistive film type or an electrostatic capacitance coupling type. Such an optical touch panel of the optical waveguide type is designed so that light beams (generally parallel light) such as infrared beams are emitted and received by optical waveguides disposed in a peripheral portion (frame portion) of a display screen (display panel) such as a monitor or a liquid crystal display device to define an optical lattice in a detection area on the display panel. The optical touch panel is used together with information (picture patterns, icons and the like) displayed on the display screen as an input/display device for guidance about the operation of an apparatus (see, for example, JP-A-2009-217468, JP-A-2009-230761 and JP-A-2010-20103).

As shown in a schematic configurational diagram of FIG. 11, touch position detection means (infrared beam emitting/receiving module) for detecting a touch position at which the optical touch panel of the optical waveguide type is touched by a finger or a special pen includes a light emitting optical waveguide A10 having light emitting cores 11 (indicated by one-dot-and-dash lines), a light receiving optical waveguide B10 having light receiving cores 12 (indicated by two-dot-and-dash lines), a light source LS and a light receiving element array PD, which are provided on a substrate 10 disposed around a rectangular liquid crystal display panel (screen) D.

A multiplicity of light beams are emitted parallel to the display panel D from distal light emitting portions 11a of the light emitting cores 11 disposed at a constant pitch (repeating pitch) P₀ on one of opposite side portions of the panel substrate 10 toward the other side portion of the panel substrate 10, and received by light receiving portions 12a of the light receiving cores 12 disposed on the other side portion in association with the light emitting portions 11a, whereby the light beams (each indicated by an arrowed broken line) travel in a horizontal direction (x-direction) and in a vertical direction (y-direction) in a lattice form on the display panel D. The core pitch P₀ defines the fineness of the optical lattice or the “resolution” of the optical touch panel.

When the detection area of the display panel D is touched by the finger or the special pen in this state, the finger or the like blocks some of the light beams. Therefore, the finger touch position (x- and y-coordinates) can be detected by detecting a light blocked portion via the light receiving cores 12 by the light receiving element array PD.

The touch panels are sometimes used for personal identification of a signature by causing a user to input characters and minute graphic patterns with the use of the finger or the special pen (stylus pen) depending on its use purpose. The touch panels designed for this purpose are required to be capable of higher definition and higher resolution detection to accurately recognize the characters and the minute graphic patterns.

To meet this requirement, it is conceivable to reduce the pitch of the optical lattice in the entire detection area on the conventional optical touch panel (i.e., to reduce the pitch of the cores of the optical waveguides).

For improvement of the overall resolution of the conventional optical touch panel including the optical lattice having the predetermined light beam pitch as described above, however, the numbers of the cores of the respective optical waveguides per unit length or the numbers of the light emitting portions and the light receiving portions per unit area should be increased. Therefore, the optical waveguides tend to have a greater size or a complicated configuration in the overall optical touch panel. Since the numbers of the cores of the respective optical waveguides are significantly increased, the light source for supplying the light beams, the light receiving elements for receiving the light beams and control means for performing control operations (computing operations) for the light source and the light receiving elements each tend to have a greater size, and are required to have a higher capacity. This results in higher total costs of the optical touch panel.

### SUMMARY OF THE INVENTION

An optical touch panel is provided which permits highly accurate detection without cost increase.

According to the present invention, there is provided an optical touch panel, which includes: a detection area; a first side portion and a second side portion disposed in opposed relation on opposite sides of the detection area and each having an inner edge; a light emitting optical waveguide including a plurality of light emitting cores which are provided in the first side portion with their distal ends disposed along the inner edge of the first side portion; and a light receiving optical waveguide including a plurality of light receiving cores which are provided in the second side portion with their distal ends disposed along the inner edge of the second side portion; wherein light beams are emitted from the distal ends of the light emitting cores and received on the distal ends of the light receiving cores to define an optical lattice on the detection area for detection of a touch position; wherein the detection area includes a higher resolution detection portion which is defined by arranging distal ends of at least some of the light receiving cores at a smaller pitch than distal ends of the other light receiving cores.

The resolution of a specific portion of the detection area of the optical touch panel of the optical waveguide type is changed in order to improve the resolution of the optical touch panel while suppressing the cost increase. The detection area includes an icon input area in which numerals and selections (Yes/No etc.) are inputted by touching icons and the like and a handwriting input area in which characters are inputted for signatures and the like by handwriting, and the icon input area and the handwriting input area require different resolutions. Since the characters each have a complicated shape and are inputted with the use of a special pen or the like, the handwriting input area requires a higher resolution than the icon input area in which the icons are touched. Where the higher resolution detection portion is defined in the handwriting input area of the optical touch panel by arranging the distal ends of at least some of the light receiving cores at a smaller pitch than distal ends of the other light receiving cores, the cost increase associated with the increase in the resolution of the optical touch panel can be suppressed.

In the inventive optical touch panel, the distal ends of some of the light receiving cores are arranged at the smaller pitch than the distal ends of the other light receiving cores to define the higher resolution detection portion required to have a higher resolution in the detection area. Therefore, a portion of the detection area other than the higher resolution detection portion may have a lower resolution equivalent to that of the detection area of the conventional touch panel. This significantly simplifies the configuration of the optical waveguides as compared with a case in which the resolution of the entire detection area is increased. Further, this makes it possible to suppress the increase in the number of the optical waveguide cores, and to use a conventional light receiving element array or its equivalent without a need for increasing the size and the capacity of the light receiving element array. As a result, the inventive optical touch panel permits highly accurate detection required by users, while minimizing the cost increase associated with the increase in resolution.

In the inventive optical touch panel, the light emitting cores may each have an arcuate lens portion at the distal end thereof. Further, the light receiving cores may each have an arcuate lens portion at the distal end thereof. In these cases, the light beams can be efficiently emitted or received through the lens portions without a need for providing separate condenser lenses.

The light emitting optical waveguide may further include a common core portion provided on a light input side, and the plurality of light emitting cores may be branched from the common core portion to extend to their distal ends on a light output side. In this case, light emitted from a light source is once guided to the common core portion, and then branched. Without a need for separately providing optical paths to guide the light emitted from the light source to the detection area, a material cost can be reduced. Thus, the optical touch panel further suppresses the cost increase associated with the increase in resolution.

The light emitting cores may each have finely branched distal end portions. Further, the light receiving cores may each have finely branched distal end portions. The finely branched distal end portions of each of the light emitting cores or the light receiving cores are equidistantly arranged in juxtaposition within a pitch width, and light beams are simultaneously emitted from the respective finely branched distal end portions of each of the light emitting cores, or simultaneously received by the respective finely branched distal end portions of each of the light receiving cores. In this case, the light beams can be emitted or received with a lower loss without a need for increasing the number of the optical waveguide cores or increasing the capacity of the light source.

In the inventive optical touch panel, the higher resolution detection portion of the detection area is a handwriting input area in which characters are inputted by handwriting. Characters for a signature or the like and minute graphic patters can be accurately inputted in a predetermined position on the optical touch panel by handwriting.

### BRIEF DESCRIPTION OF THE DRAWINGS

FIG. 1 is a diagram for explaining the operating principle of an inventive optical touch panel.

FIG. 2 is a diagram schematically illustrating an optical waveguide core pattern to be used for an optical touch panel according to a first embodiment.

FIGS. 3A and 3B are diagrams showing the configuration of light emitting distal end portions of a light emitting optical waveguide core and the configuration of light receiving distal end portions of light receiving optical waveguide cores, respectively, in the optical touch panel of the first embodiment.

FIG. 4A is a diagram showing a modification of the light emitting distal end portions of the light emitting optical waveguide core, and FIG. 4B is a diagram showing a modification of the light receiving distal end portions of the light receiving optical waveguide cores.

FIG. 5 is a diagram schematically illustrating an optical waveguide core pattern to be used for an optical touch panel according to a second embodiment.

FIGS. 6A and 6B are diagrams showing the configuration of light emitting distal end portions of a light emitting optical waveguide core and the configuration of light receiving distal end portions of light receiving optical waveguide cores, respectively, in the optical touch panel of the second embodiment.

FIG. 7 is a diagram schematically illustrating an optical waveguide core pattern to be used for an optical touch panel according to a third embodiment.

FIG. 8A is a diagram showing the configuration of light emitting distal end portions of light emitting optical waveguide cores in the optical touch panel of the third embodiment, and FIG. 8B is a diagram showing a modification of the light emitting distal end portions.

FIG. 9A is a diagram showing the configuration of light receiving distal end portions of light receiving optical waveguide cores in the optical touch panel of the third embodiment, and FIG. 9B is a diagram showing a modification of the light receiving distal end portions.

FIGS. 10A to 10C are schematic diagrams for explaining a touch panel optical waveguide production method.

FIG. 11 is a schematic diagram showing the construction of a conventional optical touch panel, and an optical waveguide core pattern used for the conventional optical touch panel.

### DETAILED DESCRIPTION OF THE INVENTION

Embodiments of the present invention will hereinafter be described in detail with reference to the attached drawings.

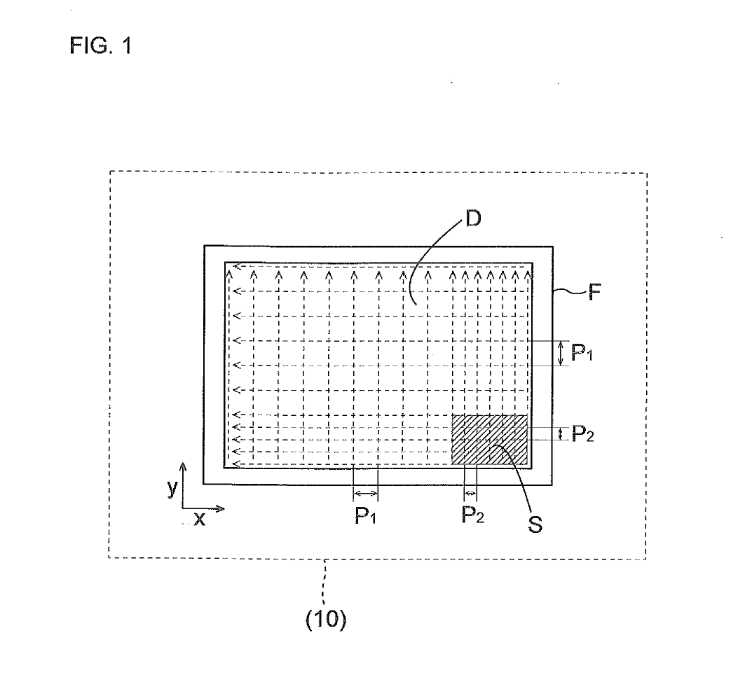

FIG. 1 is a diagram of an optical touch panel as seen from an operating side (upper side) of the optical touch panel for explaining the operating principle of the optical touch panel. In FIG. 1, there are shown a display panel D which doubles as a display screen and a touch position detection area and a decorative frame F disposed around the display panel, and a substrate (10) mounted with an infrared beam emitting/receiving module is indicated by a hidden line (broken line).

The optical touch panel is used for an apparatus, such as a bank CD or ATM, which requires input of handwritten characters such as for a signature according to displayed guidance information. As shown in FIG. 1, an invisible optical lattice is defined by a multiplicity of infrared beams (indicated by arrowed broken lines) extending vertically and horizontally. The display panel D includes a higher resolution detection area (indicated by hatching lines) defined in a lower right portion thereof (see FIG. 1) in which an optical lattice pitch (infrared beam pitch P₂) is smaller than an optical lattice pitch (infrared beam pitch P₁) of the other portion. In the higher resolution detection area, a touch position at which a finger or a pen is touched on the display panel D can be detected at a higher resolution. The higher resolution detection area serves as a handwriting input area S in which characters and minute graphic patterns can be inputted at a higher resolution with the use of the pen or the like.

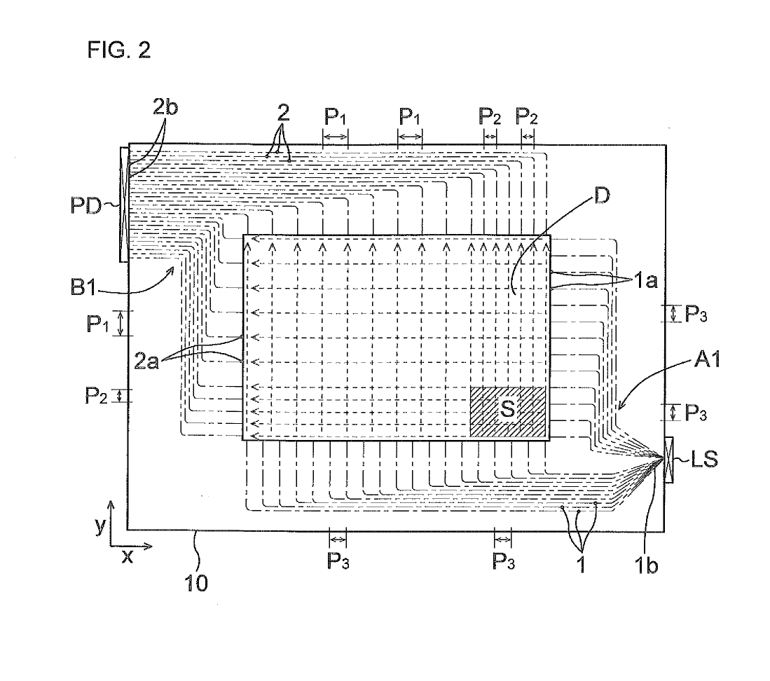

FIG. 2 schematically illustrates a first embodiment which embodies the aforementioned principle. In FIG. 2, the substrate 10 is illustrated as exposed with the frame F and a cover removed for easy understanding of the construction of the optical touch panel. Optical paths (cores) of optical waveguides that are actually invisible are indicated by one-dot-and-dash lines (for light emitting cores) and two-dot-and-dash lines (for light receiving cores), and are illustrated together with a peripheral portion of the display panel D as exaggerated in width and length.

First, the construction of an optical touch panel according to the first embodiment will be described.

As shown in FIG. 2, the optical touch panel of the first embodiment includes an infrared beam emitting/receiving module including a light emitting optical waveguide A1, a light receiving optical waveguide B1, a light source LS, and a light receiving element array PD. The light emitting optical waveguide A1 includes a branched light emitting core 1 including a common portion (proximal portion) 1b disposed on a light input side, a plurality of light emitting core branch portions 1 (indicated by the one-dot-and-dash lines) branched from the common portion 1b as generally extending in two directions (x- and y-directions), and light emitting portions 1a provided at distal ends of the light emitting core branch portions in the peripheral portion of the display panel D. The light receiving optical waveguide B1 has a plurality of light receiving cores 2 (indicated by the two-dot-and-dash lines).

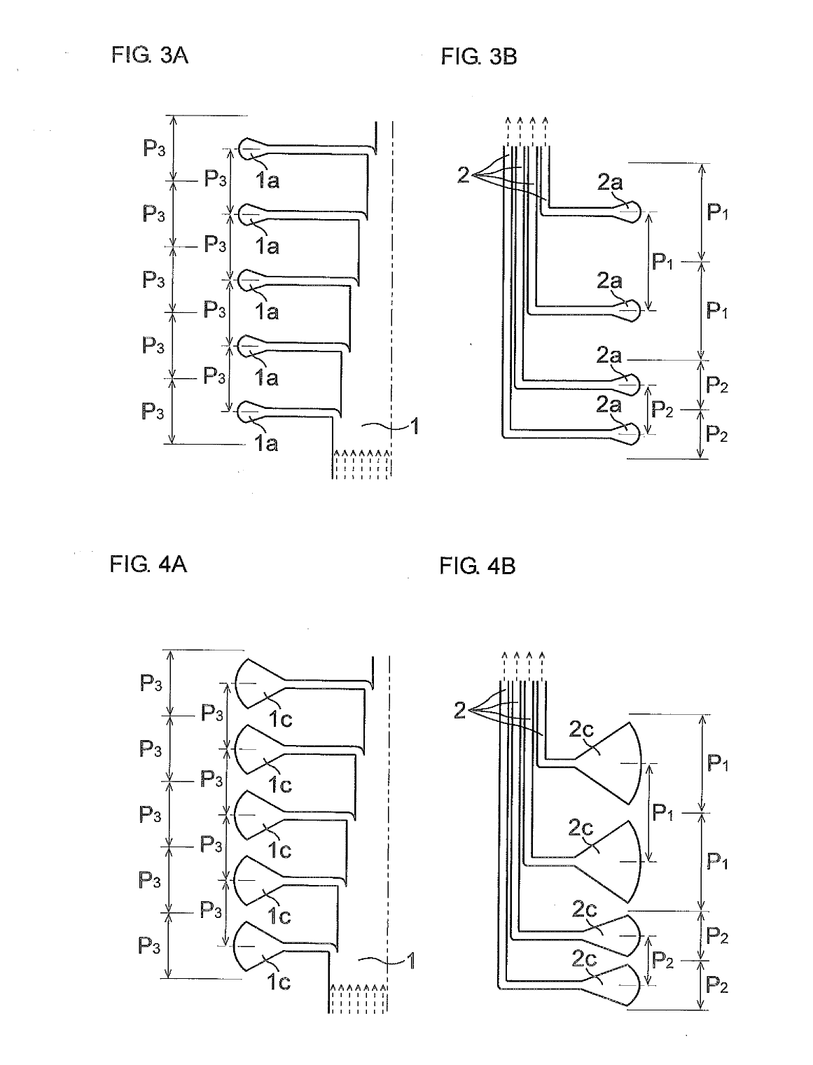

The light emitting portions 1a provided at the distal ends of the light emitting core branch portions are equidistantly arranged (at a pitch P₃) along two adjacent edges (a right side edge and a lower side edge in FIG. 2) of the peripheral portion of the display panel D. As schematically illustrated in FIG. 3A, the light emitting core branch portions are branched from the common portion 1b in the vicinity of these edges.

The light receiving cores 2 respectively include light receiving portions 2a disposed in opposed relation to the corresponding light emitting portions 1a. As schematically illustrated in FIG. 3B, some of the light receiving portions 2a for the handwriting input area S (adjacent to a lower right corner in FIG. 2) are arranged horizontally (in the x-direction) and vertically (in the y-direction) at the pitch P₂ that is smaller than the pitch P₁ of the other light receiving portions 2a for the other portion of the display panel D. With this arrangement, as shown in FIG. 2, an infrared lattice portion having a smaller pitch (indicated by arrowed broken lines) is defined in the handwriting input area S (hatched area).

The smaller pitch P₂ for the handwriting input area S is typically 0.1 to 5 mm, and the greater pitch P₁ for the other portion of the display panel D is typically 1.5 to 10 times the pitch P₂. In this embodiment, the pitch P₂ is 0.67 mm, and the pitch P₁ is 2.66 mm.

The optical waveguide will be described in greater detail. The light emitting optical waveguide A1 and the light receiving optical waveguide B1 are, for example, polymer optical waveguides, which each include an under-cladding layer (not shown) and an over-cladding layer (not shown) each formed of a resin material. The branched light emitting core 1 and the light receiving cores 2 are formed in predetermined patterns between the under-cladding layer and the over-cladding layer by a photolithography process.

As schematically illustrated in FIG. 3A, the light output end portions (light emitting portions 1a) of the branched light emitting core 1 of the light emitting optical waveguide A1 each have a lens-shaped distal end, and arranged at the pitch P₃ along a peripheral edge of the display panel D. As shown in FIG. 2, a light input end (common portion 1b) of the branched light emitting core 1 is connected (optically coupled) to the light source LS provided at the corner of the substrate 10. The light emitted from the light source LS is split in two directions, i.e., in a major edge direction and a minor edge direction, and then is further split to be guided to the respective light emitting portions 1a. The light emitting portions 1a of the branched light emitting core 1 may each have a lens shape widely spread over the entire width of the pitch P₃ as indicated by a reference character 1c in a modification shown in FIG. 4A.

As schematically illustrated in FIG. 3B, light input end portions (light receiving portions 2a) of the light receiving cores 2 of the light receiving optical waveguide B1 also each have a lens-shaped distal end like the light emitting portions 1a, and are arranged at the two pitches P₁, P₂ to be disposed at predetermined positions in the peripheral portion of the display panel D. As shown in FIG. 2, light output ends 2b of the light receiving cores 2 are connected (optically coupled) to light receiving elements of the light receiving element array PD disposed at a corner of the substrate 10, so that light beams inputted into the light receiving portions 2a are guided to the corresponding light receiving elements. The light receiving portions 2a may also each have a lens shape widely spread over the entire width of the optical lattice pitch P₁ or P₂ as indicated by a reference character 2c in a modification shown in FIG. 4B.

In the optical touch panel including the light emitting optical waveguide A1 and the light receiving optical waveguide B1 according to the first embodiment, there is no need to reduce the pitch of the infrared beams in the portion of the display panel D other than the handwriting input area S (hatched area) and the pitch of light receiving cores which receive these infrared beams. This significantly simplifies the configuration of the light receiving optical waveguide B1 as compared with the case in which the resolution of the entire detection area of the display panel D is increased.

In addition, it is possible to use a conventional light receiving element array or its equivalent as the light receiving element array PD for receiving the light beams emitted from the branched light emitting core 1 without a need for increasing the size and the capacity of the light receiving element array PD. Since the branched light emitting core 1 including the plurality of core branch portions is used in the optical touch panel, the light emitted from the light source LS is once guided to the common portion 1b, and then branched. Therefore, it is possible to reduce the size of the light source and the amount of a core material to be used. Thus, the optical touch panel according to this embodiment minimizes the cost increase associated with the increase in resolution.

A plurality of higher resolution handwriting input areas S may be provided in the panel, and the positions of the higher resolution handwriting input areas S may be properly determined depending on the use purpose. The area percentage of the higher resolution handwriting input area to the overall detection area in the display panel D is preferably 10 to 60%, more preferably 10 to 40%. If the area percentage of the handwriting input area S to the overall detection area is less than 10%, the area in which a user inputs characters for a signature or the like tends to have an insufficient size. On the other hand, if the area percentage of the handwriting input area S to the overall detection area is greater than 60%, the cost increase associated with the increase in resolution tends to be significant.

Next, the construction of an optical touch panel according to a second embodiment will be described.

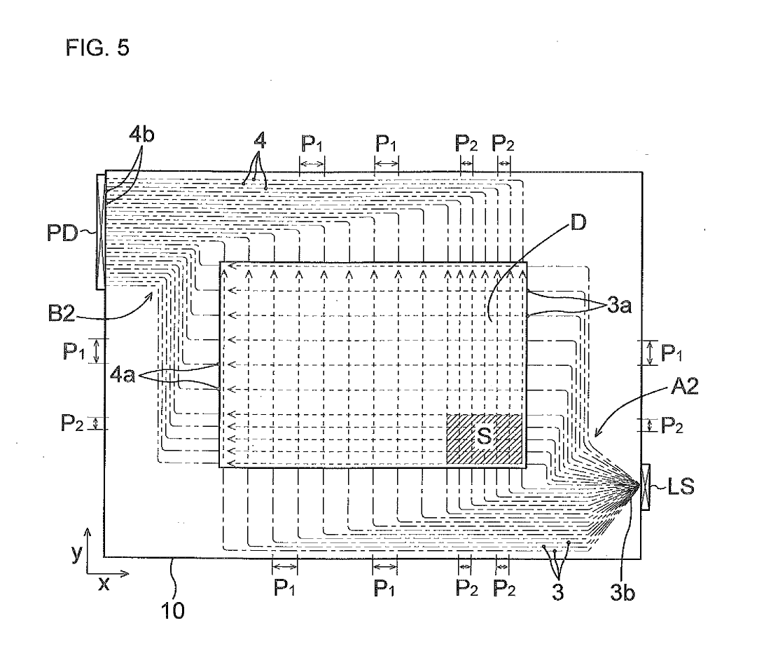

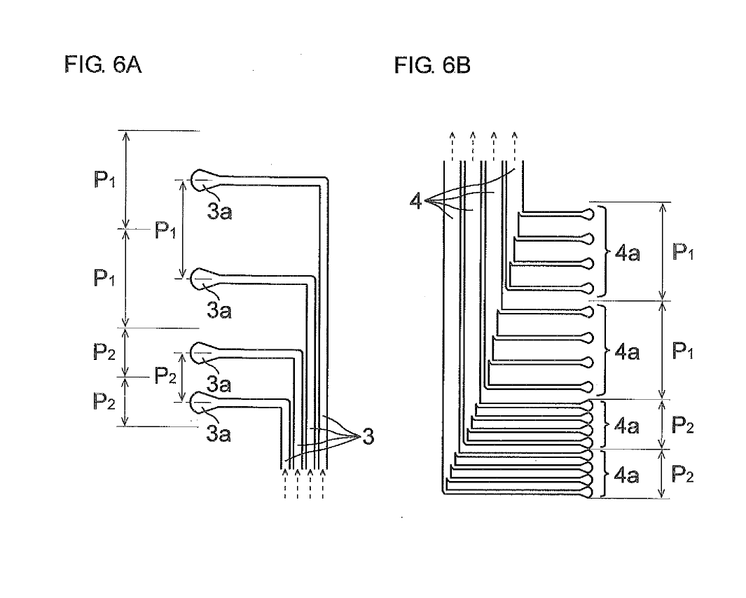

FIG. 5 is a diagram schematically illustrating an optical waveguide core pattern to be used for the optical touch panel according to the second embodiment. FIG. 6A shows the configuration of light emitting distal end portions of a branched light emitting optical waveguide core, and FIG. 6B shows the configuration of light receiving distal end portions of light receiving optical waveguide cores. A light emitting optical waveguide A2 and a light receiving optical waveguide B2 of the optical touch panel of the second embodiment have substantially the same overall constructions as those of the optical touch panel (see FIG. 2) of the first embodiment except for light emitting portions 3a and light receiving portions 4a to be described later and, therefore, will not specifically be described.

A difference between the optical touch panel of this embodiment and the optical touch panel of the first embodiment is, as schematically illustrated in FIG. 6A, that light output end portions of some light emitting core branch portions 3 for the handwriting input area S (located adjacent the lower right corner in FIG. 5) are arranged horizontally (in the x-direction) and vertically (in the y-direction) at the pitch P₂ that is smaller than the pitch P1 of light output end portions of the other light emitting core branch portions 3.

Further, light input end portions of light receiving cores 4 of the light receiving optical waveguide B2 associated with the light output end portions of the light emitting core branch portions 3 for the handwriting input area S are each finely branched into a plurality of light receiving portions 4a (four light receiving portions 4a in this embodiment) as schematically illustrated in FIG. 6B. The light receiving portions 4a branched from each of the light input end portions are equidistantly arranged within the width of the optical lattice pitch P₁ or P₂ in a pitch width direction.

Like the first embodiment, this embodiment simplifies the configuration of the light emitting optical waveguide A2 and the light receiving optical waveguide B2 as compared with the case in which the resolution of the entire detection area of the display panel D is increased. Further, this embodiment suppresses the increase in the numbers of the cores of the optical waveguides, making it possible to use the conventional light source LS and light receiving element array PD or their equivalents. In addition, the light receiving optical waveguide B2 of the optical touch panel of this embodiment efficiently utilizes the entire pitch width to receive the light beams with a lower loss. Therefore, the optical touch panel of this embodiment permits highly accurate detection required by users, while minimizing the cost increase associated with the increase in resolution.

The light emitting end portions of the light emitting core branch portions 3 may be equidistantly arranged at the pitch P₃ as shown in FIG. 3A or 4A. A branching position at which the light emitting core branch portions 3 are branched from a common portion 3b may be adjacent to the light emitting portions (distal ends) as shown in FIG. 3A, or may be adjacent to a light input end (proximal portion) as shown in FIG. 6A.

The arrangement and the shape of the distal end portions (light receiving portions) of the light receiving cores 4 may be modified. In FIG. 6B, the light receiving portions 4a branched from each of the light receiving cores 4 are arranged within the width of the optical lattice pitch P₁ or P₂. Alternatively, as shown in FIG. 3B or 4B, the light receiving portions 4a may be each disposed within the width of the optical lattice pitch P₁ or P₂, or the number of light receiving portions 4a arranged within the width of the greater pitch P₁ may be different from the number of light receiving portions 4a arranged within the width of the smaller pitch P₂. Even if the number of the light receiving portions 4a arranged within the width of the pitch P₁ or P₂ varies, these light receiving portions 4a join together into a single light receiving core on a light output side (on the side of the light receiving element array PD). Therefore, this arrangement operates in the same manner as in the case in which a single light receiving portion is present within the width of the optical lattice pitch P₁ or P₂.

Next, the construction of an optical touch panel according to a third embodiment will be described.

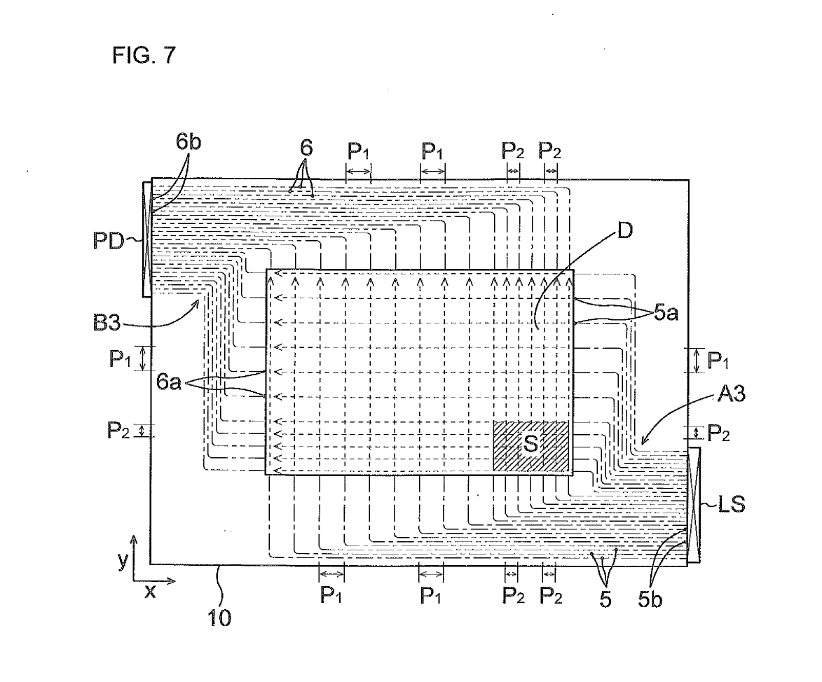

FIG. 7 is a schematic diagram showing the construction of the optical touch panel according to the third embodiment, particularly an optical waveguide core pattern to be used for the optical touch panel. A light receiving optical waveguide B3 on an infrared beam receiving side has the same configuration as the light receiving optical waveguides B1, B2 of the first and second embodiments and, therefore, will not be specifically described.

Like the optical touch panels of the first and second embodiments, the optical touch panel of the third embodiment includes an infrared beam emitting/receiving module including a light emitting optical waveguide A3 having light emitting cores 5 (indicated by one-dot-and-dash lines), a light receiving optical waveguide B3 having light receiving cores 6 (indicated by two-dot-and-dash lines), a light source LS, and a light receiving element array PD.

The optical touch panel of this embodiment differs from the optical touch panel of the second embodiment in that the light emitting optical waveguide A3 includes a plurality of light emitting cores 5 having no common portion (at their proximal portions) but respectively having light input ends 5b. The light source LS connected (optically coupled) to the light input ends 5b of the light emitting cores 5 has a wider light emitting portion than the light sources of the optical touch panels of the first and second embodiments.

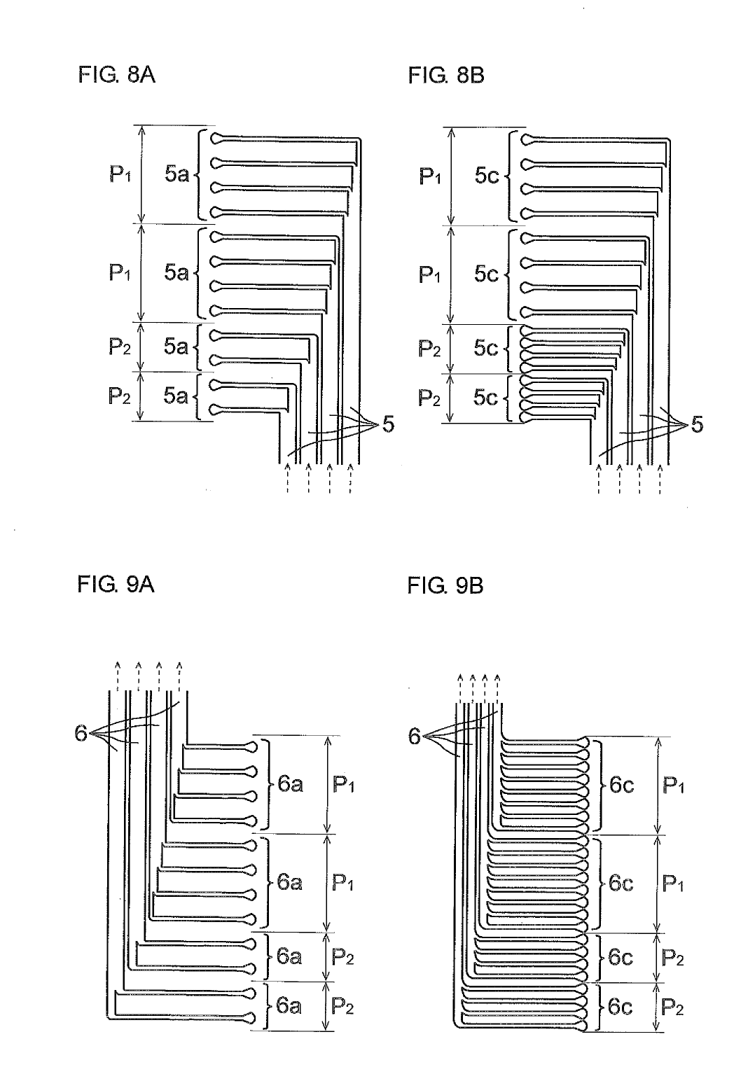

As schematically illustrated in FIG. 8A, a light output end portion of each of the light emitting cores 5 of the light emitting optical waveguide A3 is finely branched into a plurality of light emitting portions 5a, which are equidistantly arranged within the width of the optical lattice pitch P₁ or P₂ in the pitch width direction. The arrangement and the shape of the light emitting portions 5a may be modified, as shown in FIG. 8B, so that the number of light emitting portions 5c arranged within the width of the greater pitch P₁ is equal to the number of light emitting portions 5c arranged within the width of the smaller pitch P₂. Of course, the light emitting portions may be equidistantly arranged at the pitch P₃ as in the first embodiment (see FIG. 3A), or may each have a lens shape widely spread over the entire pitch width (see FIG. 4A). Further, the light emitting portions may be each disposed within the width of the pitch P₁ or P₂ as in the second embodiment (see FIG. 6A).

As schematically illustrated in FIG. 9A, a light input end portion of each of the light receiving cores 6 of the light receiving optical waveguide B3 is finely branched into a plurality of light receiving portions 6a, which are equidistantly arranged within the width of the optical lattice pitch P₁ or P₂ in the pitch width direction, like the light emitting portions 5a. The number of light receiving portions arranged within the width of the pitch P₁ or P₂ may be changed (see a modification shown in FIG. 9B). As in the first embodiment, the light receiving portions may be each disposed within the width of the pitch P₁ or P₂ (see FIG. 3B), or may each have a lens shape widely spread over the entire pitch width (see FIG. 4B). As in the second embodiment, the number of finely branched light receiving portions arranged within the width of the pitch P₁ may be equal to the number of finely branched light emitting portions arranged within the width of the pitch P₂ (see FIG. 6B).

With this arrangement, the optical touch panel of this embodiment provides the same effects as the optical touch panels of the first and second embodiments. In the optical touch panel shown in FIG. 7, a portion of the display panel D other than the handwriting input area S (hatched area) is merely required to have a resolution substantially equivalent to that of the conventional optical touch panel, thereby obviating the need for reducing the pitch of infrared beams and for reducing the pitch (P₁) of the light emitting/receiving cores of the light emitting/receiving optical waveguides. This significantly simplifies the configurations of the light emitting optical waveguide A3 and the light receiving optical waveguide B3 as compared with the case in which the resolution of the entire detection area of the display panel D is increased. Thus, the optical touch panel of this embodiment can suppress the cost increase associated with the increase in resolution.

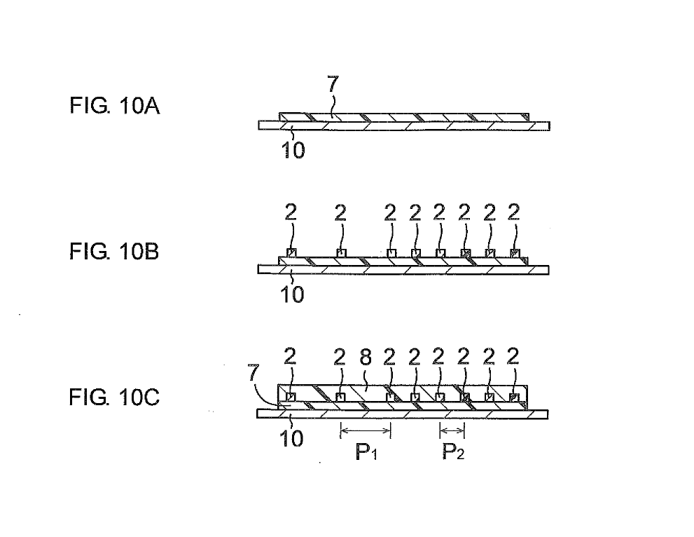

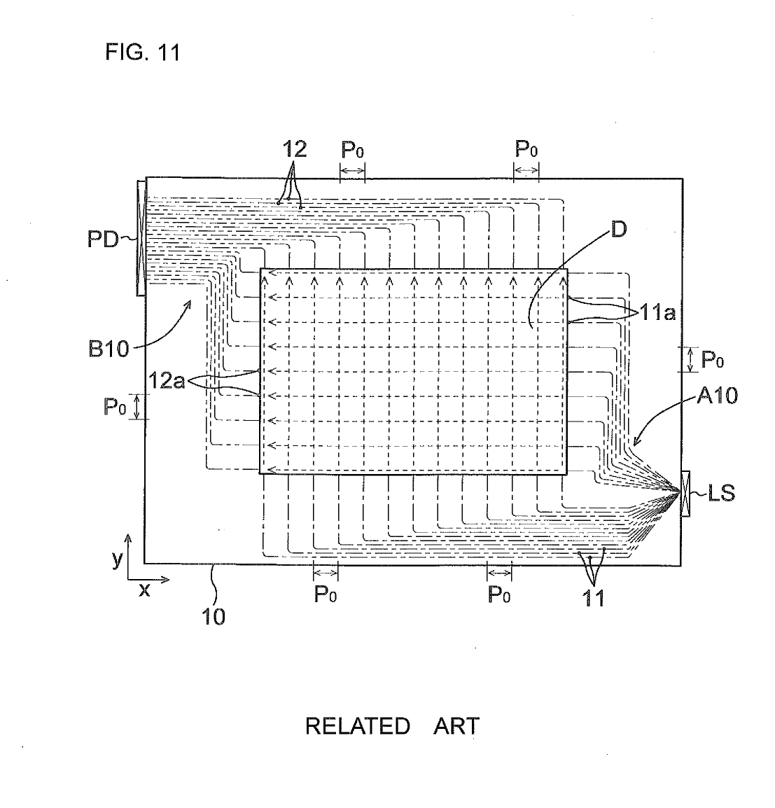

Next, a method of producing an optical waveguide to be used for the inventive optical touch panel will be described by way of example. In this method, the light receiving cores 2 are formed from a UV-curable resin by a photolithography process. FIGS. 10A to 10C to be referred to for the description are sectional views taken along a line adjacent to distal ends (light receiving portions 2a) of the light receiving cores 2. In FIGS. 10A to 10C, reference numerals 7 and 8 denote an under-cladding layer and an over-cladding layer, respectively.

First, a planar substrate 10 is prepared. Exemplary materials for the substrate 10 include glass, quartz, silicon, resins and metals. The substrate 10 has a thickness of, for example, 20 μm (film) to 5 mm (plate).

Then, as shown in FIG. 10A, an under-cladding layer 7 is formed on a predetermined region of the substrate 10. A thermosetting resin or a photosensitive resin is used as a material for the under-cladding layer 7. Where the thermosetting resin is used, the formation of the under-cladding layer 7 is achieved by applying a varnish prepared by dissolving the thermosetting resin in a solvent, and heating the resulting varnish film. On the other hand, where the photosensitive resin is used, the formation of the under-cladding layer 7 is achieved by applying a varnish prepared by dissolving the photosensitive resin in a solvent, and exposing the resulting varnish film to radiation such as ultraviolet radiation. After the exposure, a heat treatment is performed for completion of a photoreaction in some cases.

In turn, as shown in FIG. 10B, cores 2 are formed in a predetermined pattern on a surface (upper surface) of the under-cladding layer 7. Where the cores 2 are formed by the photolithography process, exemplary materials for the cores 2 include photosensitive resins (photopolymerizable resins) such as epoxy resins, polyimide resins, acryl resins, methacryl resins, oxetane resins and silicone resins, among which the epoxy resins are most preferred in consideration of costs, film thickness controllability, a loss and the like.

The core material has a higher refractive index than the under-cladding layer material and an over-cladding layer material to be described later. The refractive index may be adjusted, for example, by selection of the types of the core material and the cladding layer materials and adjustment of the composition ratio of the materials.

The photolithography process for the formation of the cores 2 will be described in detail. The formation of the cores 2 is achieved by applying a varnish of the photosensitive resin by a spin coating method, a dipping method, a die coating method, a roll coating method or the like, and irradiating the resulting varnish layer (photosensitive resin layer) with ultraviolet radiation via a photomask having a predetermined opening pattern conformal to a core pattern to expose the varnish layer in the predetermined pattern.

The opening pattern of the photomask to be used at this time is such that openings for the cores 2 for the handwriting input area S are arranged at an opening pitch (corresponding to the pitch P₂ of the cores 2) that is smaller than an opening pitch (corresponding to the pitch P₁ of the cores 2) of the openings for the cores 2 for the portion of the detection area other than the handwriting input area S. Distal end portions of the openings for the light receiving portions 2a preferably each have a convex lens shape as seen in plan (see FIG. 3B).

After the exposure step, a heat treatment is performed for completion of the photoreaction depending on the type of the photosensitive resin, and then an unexposed portion of the photosensitive resin layer is dissolved away with the use of a developing liquid by a dipping method, a spray method, a puddle method or the like for development. Thus, the cores 2 are formed as shown in FIG. 10B.

Subsequently, as shown in FIG. 10C, a thermosetting resin or a photosensitive resin is applied over the cores 2 on a surface of the under-cladding layer 7 for formation of the over-cladding layer 8. Thereafter, the over-cladding layer 8 is formed from the resulting thermosetting resin layer or photosensitive resin layer in substantially the same manner as in the formation of the under-cladding layer 7 described with reference to FIG. 10A.

In this manner, the light receiving optical waveguides B1, B2, B3 to be used for the inventive optical touch panel can be produced. The light emitting optical waveguides A1, A2 each having the branched light emitting core 1, 3, and the light emitting optical waveguide A3 having the plurality of light emitting cores 5 can be produced in the same manner as described above.

Next, an inventive example will be described in detail. However, it should be understood that the invention is not limited to this example.

### Example

In the following example, an optical touch panel according to the present invention was produced in the following manner by producing a light receiving optical waveguide and a light emitting optical waveguide by the photolithography process as in the embodiments described above, and combining the light receiving optical waveguide and the light emitting optical waveguide with a light emitting element array and a light source on a substrate.

### Under-Cladding Layer Material and Over-Cladding Layer Material

Component (A): 35 parts by weight of bisphenoxyethanolfluorene diglycidyl ether (fluorene derivative)
Component (B): 40 parts by weight of 3′,4′-epoxycyclohexyl methyl 3,4-epoxycyclohexane carboxylate (an alicyclic epoxy resin as a diluent available under CELLOXIDE 2021P from Daicel Chemical Industries, Ltd.)
Component (C): 25 parts by weight of an alicyclic epoxy resin having a cyclohexenoxide skeleton (available under CELLOXIDE 2081 from Daicel Chemical Industries, Ltd.)
Component (D): 2 parts by weight of a 50% propione carbonate solution of 4,4′-bis[di(β-hydroxyethoxy)phenylsulfinio]phenylsulfide bishexafluoroantimonate (photoacid generator)

Components (A) to (D) were mixed together, whereby an under-cladding layer material and an over-cladding layer material were prepared.

### Core Material

Component (A): 70 parts by weight of bisphenoxyethanolfluorene diglycidyl ether (fluorene derivative)
Component (E): 30 parts by weight of 1,3,3-tris{4-[2-(3-oxetanyl)]butoxyphenyl}butane
Component (D): 1 part by weight of a 50% propione carbonate solution of 4,4′-bis[di(β-hydroxyethoxy)phenylsulfinio]phenylsulfide bishexafluoroantimonate (photoacid generator)

Components (A), (E) and (D) were dissolved in 28 parts by weight of ethyl lactate, whereby a core material was prepared.

### Production of Light Receiving Optical Waveguide

The under-cladding layer material was applied onto a surface of a polyethylene naphthalate (PEN) film (160 mm 160 mm 188 μm (thickness)) by a spin coating method, and then exposed by irradiation with ultraviolet radiation at 2000 mJ/cm². In turn, the resulting under-cladding layer material film was heat-treated at 100 C for 15 minutes. Thus, an under-cladding layer was formed.

Subsequently, the core material was applied onto a surface of the under-cladding layer by a spin coating method, and then dried at 100 C for 15 minutes. A synthetic quartz-based chromium mask (exposure mask) formed with an opening pattern conformal to a core pattern was placed above the resulting core material film, which was in turn exposed from above by irradiation with ultraviolet radiation at 4000 mJ/cm² through a contact exposure method. Thereafter, the resulting core material film was heat-treated at 120 C for 15 minutes.

Then, a development process was performed by using a y-butyrolactone aqueous solution to dissolve away an unexposed portion of the core material film, and a heat treatment was performed at 120 C for 30 minutes. Thus, cores were formed. The core pattern (light receiving core pattern) was such that an optical lattice pitch P₁ for an ordinary resolution area (occupying a greater area percentage of a touch panel) was 2.66 mm, and eight light receiving portions (finely branched from each of the cores) were equidistantly arranged within the width of the pitch P₁ in a pitch width direction. For a higher resolution detection area occupying a lower right quarter of the touch panel (see FIG. 1), an optical lattice pitch P₂ was 0.67 mm which provides a resolution four times higher than the ordinary resolution, and two light receiving portions (finely branched from each of the cores) were equidistantly arranged within the width of the pitch P₂.

In turn, the over-cladding layer material was applied over the cores on the surface of the under-cladding layer by a spin coating method, and then the resulting under-cladding layer material film was exposed by irradiation with ultraviolet radiation at 2000 mJ/cm². In turn, the resulting under-cladding layer material film was heat-treated at 150 C for 60 minutes. Thus, an over-cladding layer was formed as covering the cores. In this manner, the light receiving optical waveguide was produced.

Subsequently, the light emitting optical waveguide was produced in substantially the same manner as the light receiving optical waveguide, except that the chromium mask to be used for the exposure had a different core pattern (opening pattern).

### Production of Infrared Beam Emitting/Receiving Module for Touch Panel

The light emitting optical waveguide and the light receiving optical waveguide thus produced were placed at predetermined positions on the substrate of the optical touch panel, and then the light source and the light receiving element array were placed at corners of the substrate. Thus, the infrared beam emitting/receiving module was produced.

### Mounting of Light Source

A VCSEL light source (available from Optowell Co. Ltd.) having a light emitting intensity (output) of 3 mW was placed at a predetermined position (see FIG. 2) in opposed relation to an end of a common portion of the light emitting optical waveguide, and fixed with the center of its light emitting portion (having a width of 25 μm) aligning with the optical axis of the core.

The light source was capable of emitting infrared radiation at a wavelength of 850 nm.

### Mounting of Light Emitting Element Array

A light receiving element unit (CMOS linear sensor array available from Optowell Co., Ltd.) was prepared, and positioned so as to allow light beams (signals) outputted from light output end portions of the cores of the light receiving optical waveguide to be incident on light receiving elements of the sensor array (i.e., so as to establish one-to-one correspondence between the cores and the light emitting elements) and fixed in this state.

In the optical touch panel thus produced, as shown in FIG. 1, the higher resolution area (hatched area) serving as the handwriting input area is located in a lower right position to occupy 25% (area percentage) of the overall detection area, and the other 75% area serves as an ordinary resolution area which is touched by a finger or the like for input (via icons).

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

The inventive optical touch panel is suitable for an input/display device which requires input of handwritten characters and minute graphic patterns.

What is claimed is:

1. An optical touch panel comprising:
a detection area;
a first side portion and a second side portion disposed in opposed relation on opposite sides of the detection area and each having an inner edge;
a light emitting optical waveguide including a plurality of light emitting cores which are provided in the first side portion with their distal ends disposed along the inner edge of the first side portion; and
a light receiving optical waveguide including a plurality of light receiving cores which are provided in the second side portion with their distal ends disposed along the inner edge of the second side portion;
wherein light beams are emitted from the distal ends of the light emitting cores and received on the distal ends of the light receiving cores to define an optical lattice on the detection area for detection of a touch position;
wherein the detection area includes a higher resolution detection portion which is defined by arranging distal ends of at least some of the light receiving cores at a smaller pitch than distal ends of the other light receiving cores.

2. The optical touch panel as set forth in claim 1,
wherein the light emitting cores each have an arcuate lens portion at the distal end thereof.

3. The optical touch panel as set forth in claim 1,
wherein the light receiving cores each have an arcuate lens portion at the distal end thereof.

4. The optical touch panel as set forth in claim 1,
wherein the light emitting optical waveguide further includes a common core portion provided on a light input side, and the plurality of light emitting cores are branched from the common core portion to extend to their distal ends on a light output side.

5. The optical touch panel as set forth in claim 1,
wherein the light emitting cores each have finely branched distal end portions,
wherein the finely branched distal end portions of each of the light emitting cores are equidistantly arranged in juxtaposition within a pitch width, and light beams are simultaneously emitted from the respective finely branched distal end portions of each of the light emitting cores.

6. The optical touch panel as set forth in claim 1,
wherein the light receiving cores each have finely branched distal end portions,
wherein the finely branched distal end portions of each of the light receiving cores are equidistantly arranged in juxtaposition within a pitch width, and light beams are simultaneously received by the respective finely branched distal end portions of each of the light receiving cores.

7. The optical touch panel as set forth in claim 1,
wherein the higher resolution detection portion of the detection area is a handwriting input area in which characters are inputted by handwriting.
